(19) United States
(12) Patent Application Publication
(10) Pub. No.: US 2024/0316998 A1
(43) Pub. Date: Sep. 26, 2024

(54) SPARE TIRE INFLATION

(71) Applicant: Ford Global Technologies, LLC, Dearborn, MI (US)

(72) Inventors: Edgar Butron luz, Lerma de Villada/Mexico (MX); Fernando Lozano Omana, Cuauhtemoc/Mexico City (MX); Oscar Moran, Queretaro/Queretaro (MX); Dante Arturo Rodriguez, Texcoco/Estado de Mexico (MX)

(73) Assignee: Ford Global Technologies, LLC, Dearborn, MI (US)

(21) Appl. No.: 18/187,920

(22) Filed: Mar. 22, 2023

(51) Int. Cl. B60C 23/00; B62D 43/04

(52) U.S. Cl. CPC B60C 23/001; B62D 43/04

(57) ABSTRACT

A system includes a computer including a processor and a memory. The memory stores instructions executable by the processor to actuate a compressor to maintain a spare tire of a vehicle in an uninflated state and, upon receiving data indicating a low pressure of an operating tire of the vehicle, actuate the compressor to inflate the spare tire.

### BACKGROUND

A spare tire is a tire carried on board a vehicle to use as a replacement for one of the operating tires in case the operating tire is flat or otherwise needs replacing. A spare tire typically includes a tire and a wheel to facilitate replacement. Some spare tires are the same type as the operating tires, and some spare tires are smaller than the operating tires, sometimes called compact spares.

### BRIEF DESCRIPTION OF THE DRAWINGS

FIG. 1 is a top diagrammatic view of an example vehicle.

FIG. 2 is a bottom view of a portion of the vehicle including a spare tire.

FIG. 3 is a side view of the vehicle.

FIG. 4 is a flowchart of an example process for controlling a pressure of the spare tire.

### DETAILED DESCRIPTION

This disclosure describes techniques for managing the inflation of a spare tire on board a vehicle. The spare tire may be stored on board the vehicle, e.g., on an underside of the vehicle near a rear bumper of the vehicle. A computer is programmed to actuate a compressor to maintain the spare tire in an uninflated state and, upon receiving data indicating a low pressure of an operating tire of the vehicle, actuate the compressor to inflate the spare tire. The spare tire may thus be ready to replace an operating tire in a situation in which an operator is likely to replace the operating tire with the spare tire, as indicated by the low pressure. Outside of that situation, the spare tire is kept uninflated. An uninflated spare tire may reduce a stackup of components if the vehicle is in certain impacts, compared to a fully inflated spare tire. For example, if another vehicle contacts the rear bumper of the vehicle, the rear bumper may press the spare tire inward into the vehicle. If the spare tire is uninflated rather than inflated, the distance of the intrusion by the spare tire may be reduced because the tire of the spare tire may be compressed on either side toward the wheel of the spare tire.

A system includes a computer including a processor and a memory, and the memory stores instructions executable by the processor to actuate a compressor to maintain a spare tire of a vehicle in an uninflated state; and upon receiving data indicating a low pressure of an operating tire of the vehicle, actuate the compressor to inflate the spare tire.

In an example, the system may further include the spare tire, and the spare tire may be located on an underside of the vehicle. In a further example, the spare tire may be located directly between a bumper of the vehicle and one of a fuel tank or a high-voltage battery of the vehicle. In a yet further example, the spare tire may be located at a height overlapping a vertical extent of the bumper and overlapping a vertical extent of the one of the fuel tank or the high-voltage battery.

In an example, the system may further include the compressor communicatively coupled to the computer, and the compressor may include a first outlet fluidly connected to the spare tire. In a further example, the compressor may include a second outlet not fluidly connected to the spare tire. In a yet further example, the instructions may further include instructions to, in response to a command from an operator, actuate the compressor to dispense pressurized air to the second outlet.

In another yet further example, the second outlet may be accessible from an exterior of the vehicle.

In another further example, the system may further include a control panel communicatively coupled to the compressor, and the control panel may be operable to receive input from an operator to actuate the compressor. In a yet further example, the control panel may be accessible from an exterior of the vehicle.

In another further example, the compressor may be located in an interior of the vehicle spaced from body panels of the vehicle.

In another further example, the system may further include a hose fluidly connecting the first outlet with the spare tire.

In an example, the instructions may further include instructions to, upon inflating the spare tire, actuate the compressor to maintain the spare tire in an inflated state.

In an example, the data indicating the low pressure of the operating tire may indicate that a pressure of the operating tire is below a pressure threshold.

In an example, the instructions may further include instructions to, when the spare tire is in an inflated state, upon receiving data indicating a high pressure of the operating tire, actuate the compressor to deflate the spare tire. In a further example, the data indicating the low pressure of the operating tire may indicate that a pressure of the operating tire is below a pressure threshold, and the data indicating the high pressure of the operating tire may indicate that the pressure of the operating tire is above the pressure threshold.

In an example, the instructions to actuate the compressor to inflate the spare tire may include instructions to actuate the compressor to inflate the spare tire to a recommended pressure of the spare tire. In a further example, a time for the compressor to inflate the spare tire from the uninflated state to the recommended pressure may be in a range of 1 minute to 10 minutes.

In an example, the instructions to actuate the compressor to maintain the spare tire in the uninflated state may include instructions to actuate the compressor to maintain the spare tire in the uninflated state while the vehicle is in motion.

A method includes actuating a compressor to maintain a spare tire of a vehicle in an uninflated state; and upon receiving data indicating a low pressure of an operating tire of the vehicle, actuating the compressor to inflate the spare tire.

With reference to the Figures, wherein like numerals indicate like parts throughout the several views, a system 105 of a vehicle 100 includes a computer 110 including a processor and a memory. The memory stores instructions executable by the processor to actuate a compressor 115 to maintain a spare tire 120 of the vehicle 100 in an uninflated state and, upon receiving data indicating a low pressure of an operating tire 125 of the vehicle 100, actuate the compressor 115 to inflate the spare tire 120.

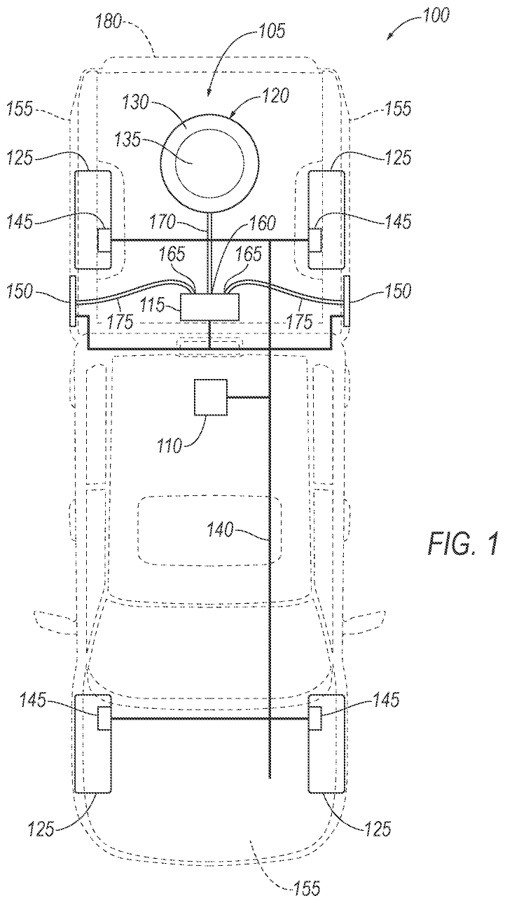

With reference to FIG. 1, the vehicle 100 may be any passenger or commercial automobile such as a car, a truck, a sport utility vehicle, a crossover, a van, a minivan, a taxi, a bus, etc.

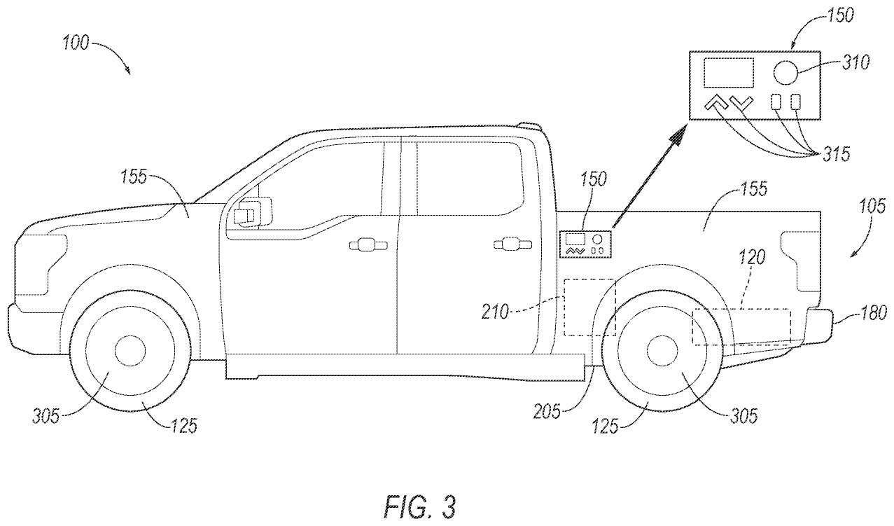

The vehicle 100 includes a plurality of the operating tires 125, typically four operating tires 125. The operating tires 125 are inflatable rings mounted to operating wheels 305 of the vehicle 100 (shown in FIG. 3). The operating tires 125 provide shock absorption and traction. Each operating tire 125 and respective operating wheel 305 defines a toroidally shaped inflation chamber that may be filled with pressurized inflation medium, such as air. The inflation chamber has a toroidal shape. The operating tires 125 may be formed of synthetic or natural rubber, or other elastomeric materials that provide sufficient elasticity, durability, and grip. The operating tires 125 may also include cords (not shown) running through the elastomeric material and/or chemical compounds added to the elastomeric material.

The vehicle 100 includes the spare tire 120. The spare tire 120 includes a tire portion 130 and a wheel portion 135. The tire portion 130 and the wheel portion 135 have the same structure as just described for the operating tire 125 and operating wheel 305. The spare tire 120 may be identical to the operating tire 125 and operating wheel 305 or may be sized differently, e.g., a compact spare.

The system 105 of the vehicle 100 includes the computer 110. The computer 110 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 110 can thus include a processor, a memory, etc. The memory of the computer 110 can include media for storing instructions executable by the processor as well as for electronically storing data and/or databases, and/or the computer 110 can include structures such as the foregoing by which programming is provided. The computer 110 can be multiple computers coupled together.

The system 105 of the vehicle 100 may include a communications network 140. The computer 110 may transmit and receive data through the communications network 140. The communications network 140 may include a controller area network (CAN) bus, Ethernet, WiFi, Local Interconnect Network (LIN), onboard diagnostics connector (OBD-II), and/or by any other wired or wireless communications network. The computer 110 may be communicatively coupled to the compressor 115, a tire-pressure-monitoring system 145, a control panel 150, and other components via the communications network 140.

The system 105 of the vehicle 100 may include the compressor 115. The compressor 115 increases the pressure of a gas by reducing a volume of the gas or by forcing additional gas into a constant volume. The compressor 115 may be any suitable type of compressor, e.g., a positive-displacement compressor such as a reciprocating, ionic liquid piston, rotary screw, rotary vane, rolling piston, scroll, or diaphragm compressor; a dynamic compressor such as an air bubble, centrifugal, diagonal, mixed-flow, or axial-flow compressor; or any other suitable type.

The compressor 115 may be located in an interior of the vehicle 100 spaced from body panels 155 of the vehicle 100. The body panels 155 partially define an exterior of the vehicle 100 and may present a class-A surface, e.g., a finished surface exposed to view by a customer and free of unaesthetic blemishes and defects. Other components of the vehicle 100 may be positioned between the body panels 155 and the compressor 115. The compressor 115 may thus be partially shielded from intrusions into the vehicle 100.

The compressor 115 includes a plurality of outlets, e.g., a first outlet 160 and at least one second outlet 165. The compressor 115 dispenses pressurized air through the outlets 160, 165. The first outlet 160 is fluidly connected to the spare tire 120, i.e., the inflation chamber of the spare tire 120. The compressor 115 may inflate the spare tire 120 by dispensing air through the first outlet 160. The second outlets 165 are not fluidly connected to the spare tire 120. For example, the second outlets 165 may be fluidly connected to an exterior of the vehicle 100, as will be described below.

The system 105 may include a first hose 170. The first hose 170 may fluidly connect the first outlet 160 of the compressor 115 with the spare tire 120. The first hose 170 may be, e.g., a flexible tube.

The system 105 may include at least one second hose 175. The second hoses 175 may fluidly connect the respective second outlets 165 to respective ports 310 on the exterior of the vehicle 100, described below with respect to FIG. 3. The second hoses 175 may be, e.g., flexible tubes.

The system 105 may include the tire-pressure-monitoring system (TPMS) 145. The TPMS 145 is a system for monitoring the air pressure of tires of a vehicle 100. The TPMS 145 returns data indicating a pressure level of the tires 120, 125. The TPMS 145 may monitor the operating tires 125 as well as the spare tire 120. The TPMS 145 may be indirect or direct. Indirect TPMS monitors information available outside of the tire to indirectly determine the air pressure. Some indirect TPMS relies on individual rotational speeds of the tires. If one tire is rotating faster than the other tires, then the tire has a smaller diameter and thus is likely underinflated. Direct TPMS uses pressure sensors mounted either inside or on an outer surface of each tire. Pressure sensors mounted inside the tires communicate using wireless short-range signals. The TPMS 145 may be different or the same for the operating tires 125 and the spare tire 120. For example, the TPMS 145 may be indirect for the operating tires 125 and direct for the spare tire 120, or the TPMS 145 may be direct for both the operating tires 125 and the spare tire 120.

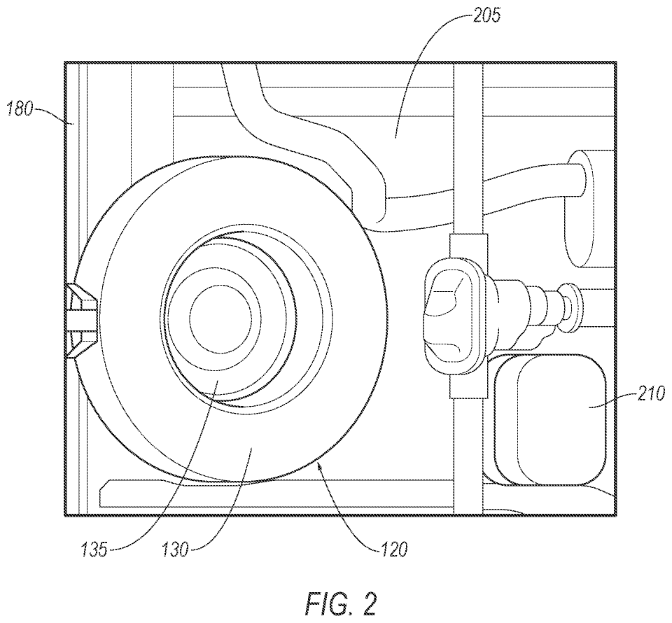

With reference to FIGS. 2 and 3, the vehicle 100 includes an energy reserve 210. The energy reserve 210 is one of a fuel tank or a high-voltage battery. For the purposes of this disclosure, “high voltage” is defined as at least 60 volts direct current or at least 30 volts alternating current. For example, the high-voltage direct current supplied by the high-voltage battery may be on the order of 400 volts. The techniques for keeping the spare tire 120 in the uninflated state below may reduce intrusion toward the energy reserve 210.

The spare tire 120 may be located in a position that is accessible to the operator but out of the way of normal use of the vehicle 100 by the operator. For example, the spare tire 120 may be located on an underside 205 of the vehicle 100. The spare tire 120 may be located directly between a bumper 180, e.g., the rear bumper, and the energy reserve 210, i.e., at least one straight line from the bumper 180 to the energy reserve 210 intersects the spare tire 120. The spare tire 120 may be located at a height overlapping a vertical extent of the bumper 180, i.e., one of a topmost point or a bottommost point of the spare tire 120 is vertically between a topmost point and a bottommost point of the bumper 180. The spare tire 120 may also be located at a height overlapping a vertical extent of the energy reserve 210.

With reference to FIG. 3, the system 105 may include the control panel 150. The control panel 150 is operable to receive input from an operator to actuate the compressor 115. For example, the control panel 150 may include inputs 315 such as buttons, knobs, keypads, and so on for receiving input from the operator. The control panel 150 may transmit commands to the computer 110 via the communications network 140. The control panel 150 may further be operable to dispense pressurized air from the compressor 115. For example, the control panel 150 may include the ports 310. The ports 310 may be shaped to facilitate attachment by a hose external to the vehicle 100 so that the pressurized air may be delivered to some apparatus separate from the vehicle 100, e.g., a bicycle tire.

The control panel 150 is accessible from an exterior of the vehicle 100. For example, the control panel 150 may be located on one of the body panels 155 of the vehicle 100, e.g., on a side of the vehicle 100. The system 105 may include two control panels 150, one on each side of the vehicle 100. The vehicle 100 may include a cover (not shown) positioned to cover the control panel 150 and openable by the operator to reveal the control panel 150.

The computer 110 may be programmed to, in response to a command from an operator, actuate the compressor 115 to dispense pressurized air to the second outlet 165. For example, the operator may provide an input to the control panel 150 via the inputs 315, and the control panel 150 may then transmit a command to the computer 110 corresponding to the input. In response to receiving the command from the control panel 150, the computer 110 may actuate the compressor 115 to dispense pressurized air through the second outlet 165. The pressurized air may exit from the port 310 on the control panel 150 to whatever device the operator has connected to the port 310. In the case of multiple control panels 150 and multiple second outlets 165, the computer 110 may actuate the compressor 115 to dispense pressurized air to the second outlet 165 connected to the control panel 150 from which the command was received.

Returning to FIG. 1, the computer 110 may be programmed to receive data indicating pressures of the operating tires 125, e.g., data from the TPMS 145. The data from the TPMS 145 may indicate a low pressure of the operating tire 125, e.g., that the pressure is below a pressure threshold, or the data from the TPMS 145 may indicate a high pressure of the operating tire 125, e.g., that the pressure is above the pressure threshold. The pressure threshold may be chosen to indicate whether the pressure is within a recommended range of operating pressures for the operating tires 125, i.e., pressures above the pressure threshold are within the recommended range and pressures below the pressure threshold are below the recommended range. The data from the TPMS 145 may include numerical values for the pressures, e.g., by returning some value that is correlated with the pressure such as a voltage generated by a pressure sensor. The computer 110 may then compare the returned pressure with the pressure threshold to determine whether the pressure is above or below the threshold. Alternatively, the data from TPMS 145 may directly indicate whether one of the pressures is above or below a threshold, e.g., by sending a message when the pressure is below a pressure threshold and not sending a message when the pressure is above the pressure threshold.

The computer 110 is programmed to actuate the compressor 115 to maintain the spare tire 120 in the uninflated state, e.g., as a default condition, e.g., upon receiving data indicating a high pressure of the operating tire 125, e.g., of all the operating tires 125. For example, the computer 110 may actuate the compressor 115 to provide an open pathway for air to exit the spare tire 120 through the first hose 170 and the first outlet 160. The pressure of the spare tire 120 may thus be maintained at approximately equal to atmospheric pressure. For another example, the computer 110 may actuate the compressor 115 to operate in reverse and pull air from the spare tire 120 through the first hose 170 and the first outlet 160. The pressure of the spare tire 120 may thus be maintained below atmospheric pressure. The computer 110 may actuate the compressor 115 to maintain the spare tire 120 in the uninflated state while the vehicle 100 is in motion, e.g., both while the vehicle 100 is in motion and while the vehicle 100 is stationary. Maintaining the spare tire 120 in the uninflated state while the vehicle 100 is in motion may reduce a stackup of components in the event of certain impacts to the vehicle 100 while traveling.

The computer 110 is programmed to, upon receiving data indicating a low pressure of the operating tire 125, e.g., of at least one of the operating tires 125, actuate the compressor 115 to inflate the spare tire 120. The computer 110 actuates the compressor 115 to inflate the spare tire 120 from the uninflated state to an inflated state by dispensing pressurized air from the first outlet 160. The computer 110 may actuate the compressor 115 to inflate the spare tire 120 to a recommended pressure of the spare tire 120. The recommended pressure may be provided by a manufacturer of the spare tire 120. The computer 110 may store the recommended pressure in memory. A time for the compressor 115 to inflate the spare tire 120 from the uninflated state to the recommended pressure may be in a range of 1 minute to 10 minutes, e.g., in a range of 3 minutes to 8 minutes. The inflation time is short enough so that, in the event of the pressure of one of the operating tires 125 falling below the pressure threshold, the spare tire 120 is inflated in time for the operator to replace the low-pressure operating tire 125 with the spare tire 120. The inflation time is long enough to reduce the power demands on the compressor 115 of inflating the spare tire 120.

The computer 110 may be programmed to, upon inflating the spare tire 120, actuate the compressor 115 to maintain the spare tire 120 in the inflated state. For example, the computer 110 may actuate the compressor 115 to inflate the spare tire 120 in response to the pressure of the spare tire 120 decreasing below a margin from the recommended pressure. The margin may be chosen as a typical range of pressures in use around the recommended pressure. The margin may be provided by the manufacturer of the spare tire 120, e.g., as a range of recommended pressures. For another example, the computer 110 may actuate the compressor 115 to close the first outlet 160, so as to fluidly isolate the spare tire 120 in the inflated state. The computer 110 may actuate the compressor 115 to maintain the spare tire 120 in the inflated state until the operating tires 125 all have high pressures, e.g., pressures above the pressure threshold, such as from the operator reinflating the low-pressure operating tire 125 (or until the spare tire 120 is used to replace one of the operating tires 125, in which case the compressor 115 is no longer fluidly connected to the spare tire 120).

The computer 110 may be programmed to, when the spare tire 120 is in an inflated state, upon receiving data indicating a high pressure of the operating tire 125, actuate the compressor 115 to deflate the spare tire 120. The computer 110 may actuate the compressor 115 to deflate the spare tire 120 upon receiving data indicating a high pressure of the operating tire 125 that has previously had a low pressure or upon receiving data indicating high pressures for all the operating tires 125. For example, the computer 110 may actuate the compressor 115 to provide an open pathway for air to exit the spare tire 120 through the first hose 170 and the first outlet 160. The pressure of the spare tire 120 may thus be reduced to approximately equal to atmospheric pressure. For another example, the computer 110 may actuate the compressor 115 to operate in reverse and pull air from the spare tire 120 through the first hose 170 and the first outlet 160. The pressure of the spare tire 120 may thus be reduced below atmospheric pressure. The spare tire 120 is thus not maintained in the inflated state after the operator has reinflated the previously low operating tire 125.

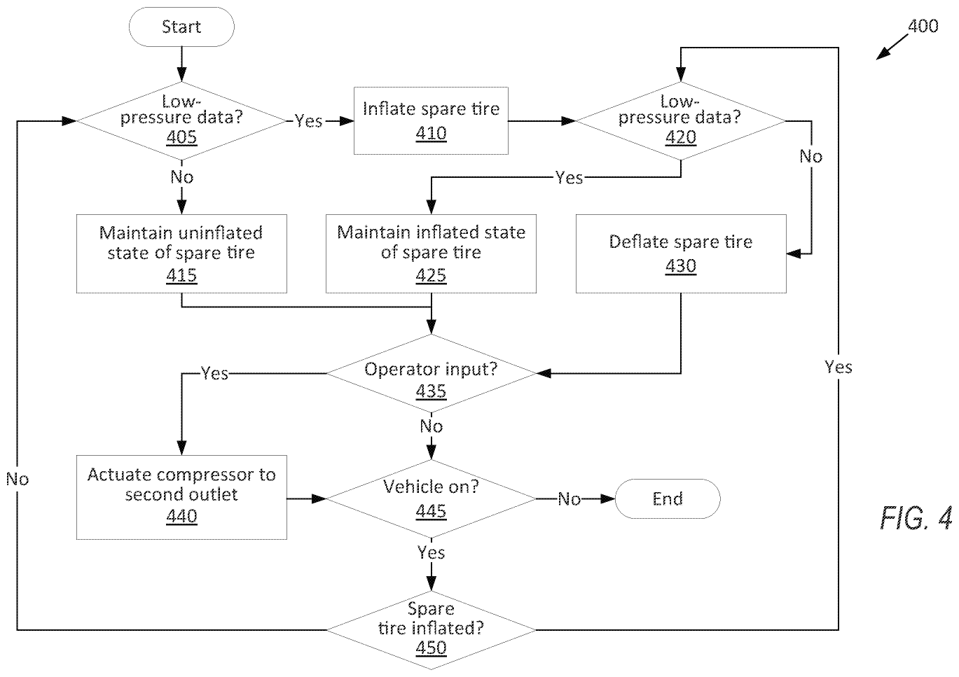

FIG. 4 is a process flow diagram illustrating an example process 400 for controlling the pressure of the spare tire 120. The memory of the computer 110 stores executable instructions for performing the steps of the process 400 and/or programming can be implemented in structures such as mentioned above. As a general overview of the process 400, the computer 110 actuates the compressor 115 to inflate the spare tire 120 upon receiving data indicating a low pressure of an operating tire 125, and actuates the compressor 115 to maintain the spare tire 120 in the uninflated state upon receiving data indicating a high pressure of the operating tires 125. After inflating the spare tire 120, the computer 110 actuates the compressor 115 to maintain the spare tire 120 in the inflated state upon receiving data indicating the continued low pressure of the operating tire 125, and actuates the compressor 115 to deflate the spare tire 120 upon receiving data indicating a high pressure of the operating tire 125. The computer 110 actuates the compressor 115 to dispense pressurized air from the second outlet 165 in response to a command from an operator. The process 400 continues for as long as the vehicle 100 remains on.

The process begins in a decision block 405, in which the computer 110 determines whether data from the TPMS 145 indicates high pressure of the operating tires 125 or low pressure of at least one of the operating tires 125, as described above. Upon receiving data indicating a low pressure of at least one operating tire 125, the process 400 proceeds to a block 410. Upon receiving data indicating high pressures of the operating tires 125, the process 400 proceeds to a block 415.

In the block 410, the computer 110 actuates the compressor 115 to inflate the spare tire 120, as described above. The computer 110 may set a flag in memory to indicate that the spare tire 120 is being maintained in the inflated state. The flag may have a binary value indicating whether the spare tire 120 is being maintained in the inflated state or in the uninflated state, e.g., “1” for inflated and “0” for uninflated. After the block 410, the process 400 proceeds to a decision block 420.

In the block 415, the computer 110 actuates a compressor 115 to maintain the spare tire 120 in the uninflated state, as described above. The computer 110 may set the flag in memory indicating that the spare tire 120 is being maintained in the uninflated state. After the block 415, the process 400 proceeds to a decision block 435.

In the decision block 420, the computer 110 determines whether data from the TPMS 145 indicates high pressure of the operating tires 125 or low pressure of at least one of the operating tires 125, as described above. Upon receiving data indicating a low pressure of at least one operating tire 125, the process 400 proceeds to a block 425. Upon receiving data indicating high pressures of the operating tires 125, the process 400 proceeds to a block 430.

In the block 425, the computer 110 actuates the compressor 115 to maintain the spare tire 120 in the inflated state, as described above. The computer 110 may set the flag in memory indicating that the spare tire 120 is being maintained in the inflated state. After the block 425, the process 400 proceeds to the decision block 435.

In the block 430, the computer 110 actuates the compressor 115 to deflate the spare tire 120, as described above. The computer 110 may set the flag in memory indicating that the spare tire 120 is being maintained in the uninflated state. After the block 430, the process 400 proceeds to the decision block 435.

In the decision block 435, the computer 110 determines whether a command from the operator to actuate the compressor 115 has been received, e.g., via the control panel 150, as described above. In response to a command from the operator, the process 400 proceeds to a block 440. If no command has been received, the process 400 proceeds to a decision block 445.

In the block 440, the computer 110 actuates the compressor 115 to dispense pressurized air to the second outlet 165, as described above. After the block 440, the process 400 proceeds to the decision block 445.

In the decision block 445, the computer 110 determines whether the vehicle 100 is still on. If so, the process 400 proceeds to a decision block 450. If the vehicle 100 has been turned off, the process 400 ends.

In the decision block 450, the computer 110 determines whether the spare tire 120 is being maintained in the inflated state or the uninflated state. The computer 110 may check whether the flag stored in memory indicates that the spare tire 120 is being maintained in the inflated state (e.g., is set to “1”) or that the spare tire 120 is being maintained in the uninflated state (e.g., is set to “0”). If the most recently executed block of the blocks 410, 415, 425, and 430 is either the block 410 or 425, the flag will be set to indicate that the spare tire 120 is being maintained in the inflated state. If the most recently executed block of the blocks 410, 415, 425, and 430 is either the block 415 or 430, the flag will be set to indicate that the spare tire 120 is being maintained in the uninflated state. In response to the spare tire 120 being maintained in the inflated state, the process 400 returns to the decision block 420 to determine whether or not to deflate the spare tire 120. In response to the spare tire 120 being maintained in the uninflated state, the process 400 returns to the decision block 405 to determine whether or not to inflate the spare tire 120.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. The adjectives “first” and “second” are used throughout this document as identifiers and are not intended to signify importance, order, or quantity. Use of “in response to” and “upon determining” indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system comprising:
a computer including a processor and a memory, the memory storing instructions executable by the processor to:
actuate a compressor to maintain a spare tire of a vehicle in an uninflated state; and
upon receiving data indicating a low pressure of an operating tire of the vehicle, actuate the compressor to inflate the spare tire.

2. The system of claim 1, further comprising the spare tire, wherein the spare tire is located on an underside of the vehicle.

3. The system of claim 2, wherein the spare tire is located directly between a bumper of the vehicle and one of a fuel tank or a high-voltage battery of the vehicle.

4. The system of claim 3, wherein the spare tire is located at a height overlapping a vertical extent of the bumper and overlapping a vertical extent of the one of the fuel tank or the high-voltage battery.

5. The system of claim 1, further comprising the compressor communicatively coupled to the computer, wherein the compressor includes a first outlet fluidly connected to the spare tire.

6. The system of claim 5, wherein the compressor includes a second outlet not fluidly connected to the spare tire.

7. The system of claim 6, wherein the instructions further include instructions to, in response to a command from an operator, actuate the compressor to dispense pressurized air to the second outlet.

8. The system of claim 6, wherein the second outlet is accessible from an exterior of the vehicle.

9. The system of claim 5, further comprising a control panel communicatively coupled to the compressor, wherein the control panel is operable to receive input from an operator to actuate the compressor.

10. The system of claim 9, wherein the control panel is accessible from an exterior of the vehicle.

11. The system of claim 5, wherein the compressor is located in an interior of the vehicle spaced from body panels of the vehicle.

12. The system of claim 5, further comprising a hose fluidly connecting the first outlet with the spare tire.

13. The system of claim 1, wherein the instructions further include instructions to, upon inflating the spare tire, actuate the compressor to maintain the spare tire in an inflated state.

14. The system of claim 1, wherein the data indicating the low pressure of the operating tire indicates that a pressure of the operating tire is below a pressure threshold.

15. The system of claim 1, wherein the instructions further include instructions to, when the spare tire is in an inflated state, upon receiving data indicating a high pressure of the operating tire, actuate the compressor to deflate the spare tire.

16. The system of claim 15, wherein the data indicating the low pressure of the operating tire indicates that a pressure of the operating tire is below a pressure threshold, and the data indicating the high pressure of the operating tire indicates that the pressure of the operating tire is above the pressure threshold.

17. The system of claim 1, wherein the instructions to actuate the compressor to inflate the spare tire include instructions to actuate the compressor to inflate the spare tire to a recommended pressure of the spare tire.

18. The system of claim 17, wherein a time for the compressor to inflate the spare tire from the uninflated state to the recommended pressure is in a range of 1 minute to 10 minutes.

19. The system of claim 1, wherein the instructions to actuate the compressor to maintain the spare tire in the uninflated state include instructions to actuate the compressor to maintain the spare tire in the uninflated state while the vehicle is in motion.

20. A method comprising:
actuating a compressor to maintain a spare tire of a vehicle in an uninflated state; and
upon receiving data indicating a low pressure of an operating tire of the vehicle, actuating the compressor to inflate the spare tire.
